(19) United States
(12) Patent Application Publication
(10) Pub. No.: US 2008/0195839 A1
(43) Pub. Date: Aug. 14, 2008

(54) Reconfigurable, Modular and Hierarchical Parallel Processor System

(75) Inventors: Hildegarde Francisca Felix Nuyens, Lanaken (BE); Pierre Guilmette, Cagnes Sur Mer (FR); Serge Glories, Lanaken (BE)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Hildegarde Francisca Felix NUYENS, Lanaken (BE)

(21) Appl. No.: 11/665,882

(22) PCT Filed: Oct. 14, 2005
(86) PCT No.: PCT/EP05/11169

§ 371 Date: Dec. 3, 2007

(30) Foreign Application Priority Data
Oct. 18, 2004 (FR) 0411020

(51) Int. Cl. G06F 15/76; G06F 9/30

(52) U.S. Cl. 712/1; 712/E09.016

(57) ABSTRACT

The invention concerns a method for managing resources of a modular processor system comprising the following steps of transmitting an instruction of a programme contained in a first machine with higher level status to a second machine with lower level status to manage the running of the programme; attributing links between the different cells which contain the incoming data and the operators of the block of the machine with lower level status to perform the placement of said incoming data; attributing links between the operators of the block of the machine with lower status to perform processing of said incoming data; and reconfiguring the links between the different operators by the machine with lower level status, during the execution of the programme instructions, based on outgoing data obtained from processing of the incoming data.

### FIELD OF THE INVENTION

The present invention relates to a parallel processor system having a reconfigurable and hierarchical structure.

### BACKGROUND OF THE INVENTION

The sequential operation of most current processors advantageously economizes on resources (logic gates) at the cost of reduced performance linked directly to operations being effected in succession, so sequential processors must be at the cutting edge of integrated circuit speed and integration. Similarly, operation instructions (code) must be read sequentially over ever longer instruction words, making the introduction of parallel processes difficult unless including words of 128, 256 or more bits.

In practice, current processors must support program structures that appear parallel by producing a multitasking execution structure. However, such a structure does not provide real simultaneity and represents a heavy load. In particular, multitasking requires additional management by the processor, made necessary if priorities are to be shared between the various tasks; such a heavy load has consequences: greater memory capacity is required (allocation of memory blocks per task), and a reduction of performance is caused by the fact that some resources are dedicated to task management.

Some systems introduce multiple processors interconnected in a common environment in which they share resources and data. Although offering better performance than that having only one processor, this architecture has the drawback of being costly in interface components and its performance is limited by the capacity for exchange of data on a common bus.

The introduction of parallelism is a priori costly; systems have introduced it and necessitate considerable resources. To a large degree these systems offer very high performance at the cost of a lack of flexibility and of wasting resources in that a large portion of the functions are not used to their full potential. In this instance, a parallel processor must exploit new structures enabling dynamic allocation of resources and efficient and economical exchange of data between resources.

In French patent No. 2 783 630, application filed 23 Sep. 1998, and U.S. Pat. No. 6,137,044, application filed 23 Sep. 1999 and issued 24 Oct. 2000, the cell concept is introduced into a system for parallelization of sound signals in which the calculation elements are shared between cells and in which the inputs and outputs of the cells are interconnected by programmable links. Although they are shared (numerous parallel operations used sequentially), resources can be grouped together and an architecture can incorporate a plurality of these groups having their own resources in parallel at the same time as being capable of being linked in a programmable manner. The above patent introduces fully modular means for rendering these links programmable. The architecture described in the patent cited above is built around the concept of cells sharing calculation resources and offers solutions in the signal and time field (recursive mode) although it can equally well offer solutions in the more general field of calculating and data processing machines (non-recursive mode).

Consequently, there remains a great deal of room for methods and systems that solve the principal limitations of existing processors and generalize parallel processing to any type of data and signals.

### SUMMARY OF THE INVENTION

The present invention introduces the functions of a parallel processor the elements whereof are configurable and reconfigurable in real time and dynamically. The processing and calculation resources are used by each cell independently, with or without sharing. The input data of the cells is linked to registers the values whereof come from variables or from calculation results from other resources. The cells are grouped into first level blocks. Those blocks can be grouped in turn, and so on. A state machine commands the operation of each group of level 1 or higher, in accordance with a program and if required reconfigurable in accordance with chosen results. The level 1 blocks include accumulators with multiple outputs that enable dynamic redirection of partial data from the outputs of cells, these accumulators enabling crossed calculations with programmable indexing. The higher level integrates all the levels and also contains a state macromachine that manages the operation of the subsystems. In this instance the processor is constituted of hierarchical elements on a plurality of levels, the elementary level constituting the cell; this hierarchical organization enables communication of data on simple calculations (low level) and on blocks of calculations (higher levels).

This structure is fully parallel and entirely reconfigurable dynamically on external data or as a function of results obtained.

The modular processor system is based on a hierarchical architecture enabling processing and calculation to be effected on data in memory in order to obtain data; said system comprises means for effecting arithmetic, logic, storage operations in parallel manner using resources in an adapted and reconfigurable structure including grouped operators disposed in whole or in part around a set of cells, available on a time sharing or predetermined basis in a flexible manner in all combinations, themselves grouped into blocks, in which cells and blocks data can be exchanged in programmable manner, so that processing can be effected independently and simultaneously using resources configured dynamically as required.

The system is advantageously characterized in that the routing of the input and output data can be effected dynamically and independently at each input, output and calculation resource and on the basis of particular values in predefined memories corresponding to the links between the sources and the destinations.

The system is advantageously characterized in that the various data links take account of the synchronization to compensate for the delays between the various inputs for each resource including a plurality of inputs such as the operators, the cells and the blocks of cells.

The system is advantageously characterized in that the incoming data is directed dynamically to the groups of operators from an external processor or from input interfaces from external devices, the routing of the data to the groups being reconfigurable dynamically as required.

The system is advantageously characterized in that the outgoing data is transmitted to memories or to external devices or output interfaces.

The system is advantageously characterized in that said means for effecting arithmetic or logic or storage processing on operators incorporated in cells comprise:
a circuit for configuration of the inputs of the various logic and arithmetic operators grouped into blocks, shared by cells and accessible by cells chosen dynamically;
a circuit for configuration of the inputs of the various logic and arithmetic operators in part assigned in fixed manner to cells according to the configuration requirements and alternatively to shared operator configurations;
an independent circuit for selection of the source of each input for each input of each operator;
a circuit for capture of output data in the form of accumulators including flip-flops the synchronization whereof can be parametered independently;
a synchronization circuit in the form of programmable counters for commanding sequences usable at the various processing levels, as required and configurable independently for each element;
a storage command circuit for the storage type operators;
an arithmetic and logic calculation circuit for the calculation, comparison or decision type operators;
a delay circuit using flip-flops for appropriate synchronization of the operator inputs for each input independently;
a circuit for grouping operators in cells including configuration registers giving the connection links for each operator input, the synchronization modes, the direction of the outputs, the connections between the operators of a cell, the connections between the cells, the connections external to the cells.

In the system for processing data at one or more levels, command is effected at each level by processes of processor-controller type or state machines and the higher levels instruct operations on the lower levels and the modes of calculation and of operation of each resource and the data links between the various resources are determined dynamically.

Advantageously, the circuit for selection of the source of the inputs on each level, in this instance the links on a plurality of levels, comprises:
a circuit for the selection of the sources of the inputs of operators in particular arithmetic, logic, storage functions, which circuit routes the outputs of other elements, whether that be other operators, cells, groups (in the description of the level 1 or other blocks), programmable counters or other circuit elements, direct data, to one or the other input of each operator, independently for each input of each operator;
a circuit for the selection of the sources of the inputs of cells, which circuit routes the outputs of other elements, whether that be cells, groups (in the description of the level 1 or other blocks), or selective group accumulators, programmable counters, operators or other circuit elements, direct data, to one or the other input of each cell, independently for each input of each cell;
a circuit for the selection of the sources of the inputs of groups of cells called level 1 blocks or higher level blocks incorporating lower level blocks, which circuit routes outputs of other elements, whether that be cells, groups (in the description of the level 1 or other blocks), or selective group accumulators, programmable counters, operators or other circuit elements, direct data, to one or the other input of each group, independently for each input of each group.

The cell circuit advantageously groups calculation or processing elements comprising:
memories, logic or arithmetic operators;
a circuit for selection of links between the elements of the cell at the inputs and outputs;
a circuit for selection of the links external to the cell enabling connection of different inputs or outputs of cells, operators, accumulators of cells, groups of cells or input data.

The process command circuit of the cells advantageously comprises:
programmable counters;
counter commands for the start, end and incrementation/decrementation values;
counter commands for activation of counting, setting to zero, loading of programming values and counting direction.

The circuit for selective accumulation of the inputs of the cells advantageously comprises:
outputs of elements to be selected including outputs of other cells, outputs of groups of cells, outputs of accumulators of groups of cells, outputs of operators, etc.;
a circuit for selection of inputs from programmed registers or programmed state machines, etc.

The circuit for grouping cells advantageously groups cells comprising:
memories, logic or arithmetic operators available to receive data from cells or from other sources, calculate and route results to other cells;
a circuit for selection of links between the cells at the inputs and outputs;
a circuit for selection of links external to the group enabling connection of different inputs or outputs of cells, operators, accumulators of cells, groups of cells or direct inputs.

The cell group process command circuit advantageously comprises:
programmable counters;
counter commands for the start, end and incrementation/decrementation values;
counter commands for activation of counting, setting to zero, loading programming values and counting direction.

The circuit for selective accumulation of the outputs of the cells comprises:
stored cell outputs;
a programmable selection circuit for choosing the values of cells to be added in a given clock cycle;
a circuit for commanding selection of values from counters or programmable state machines commanding the circuit for selection of cells to be added in a given cycle;
a programmable selection circuit for choosing the cell accumulators over a given clock cycle;
a circuit for commanding the selection of values from counters or programmable state machines commanding the circuit for selection of the accumulators over a given cycle;
a parallel adder of the values of the cells with selection of the inputs by the device for selection of outputs of cells to be added in a given cycle;
memories commanded selectively to assume the values added in a chosen cycle;
memories commanded cyclically for synchronizing the outputs of the memories selected in chosen cycles and transmitted in other cycles.

### DESCRIPTION OF THE FIGURES

The figures represent a structure with three levels: higher level, level 1, cells. The architecture is not limited to this number of levels, however, and could equally well feature a number of levels larger or smaller than three.

FIG. 1 (1a, 1b) represents the higher level of the architecture which contains in particular the first state machine that commands all of the architecture and the Level 1 blocks.

FIG. 2 (2a, 2b, 2c) represents the elements of a Level 1 block shown in FIG. 1, which includes its own state machine—supervised by the first state machine, its configuration registers, the process commands, the block cells, the operators and the multiple-output accumulator. It constitutes a set of one or more calculations effected on the cells.

FIG. 3 (3a, 3b, 3c) represents the elements of a cell shown in FIG. 2, including the configuration registers, the process commands, the input accumulator, data from which is routed selectively to the operators, the operator selectors and the output accumulator of the cell.

FIG. 4 represents in detail process commands in a level 1 block as shown in FIG. 2.

FIG. 5 represents in detail the multiple-output accumulator of the cells, shown in FIG. 2, including the synchronization of outputs coming from each cell which are combined (adder 501) and directed selectively to one or more outputs.

FIG. 6 represents in detail process commands in a cell as shown in FIG. 3, including programmable counters the values from which can be used in commands specific to each cell.

FIG. 7 represents in detail the input accumulator of a cell, shown in FIG. 3, including multiplexers directing level 1 outputs to one or more operators of the cell as required.

FIG. 8 represents in detail a generic operator, shown in FIG. 2, including selectors for choosing the source of each operator input, synchronizers for the ‘pipeline’ and the operation function as such, which can be an arithmetic or logic function: adder-subtractor, multiplier, divider, linear/non-linear function table, comparator, memory or register, bit shifter unit, etc.

FIG. 9 represents in detail the output accumulator of the cell, shown in FIG. 3, which chooses one or the other output of the operator as the specific output of a given cell.

### DETAILED DESCRIPTION OF THE INVENTION

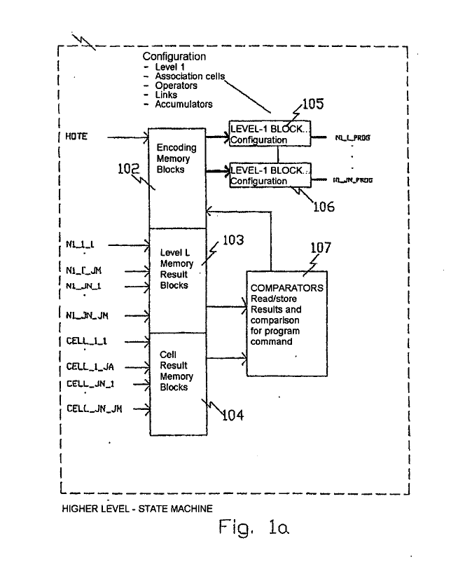

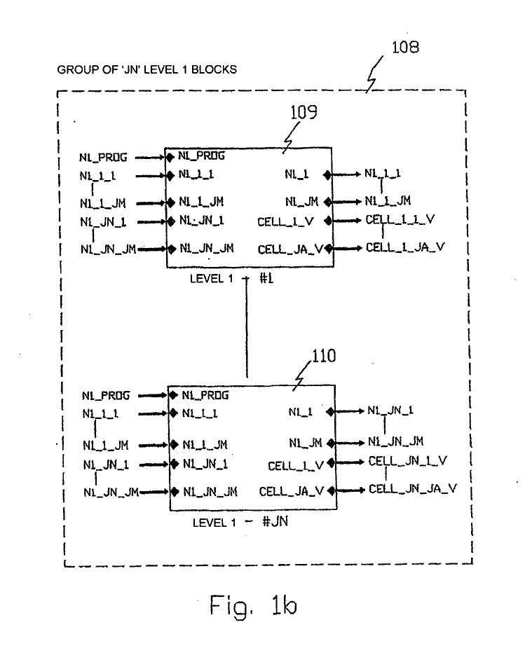

Generally speaking, the present invention proposes a modular, reconfigurable and hierarchical processor using parallel calculation and processing. The data supplied for calculation and processing may come firstly from memories, external processors or input/output interfaces. The hierarchical configuration of the elements, in particular the links between them, may be commanded by an external processor that processes and decides on the evolution of the configuration in accordance with the calculations executed, or by the introduction of state machines (101) as shown in FIG. 1a, in which case the processor may act autonomously as much as in an evolving manner by virtue of the fact that the data resulting from the calculations may be evaluated by the state machine 101, which acts as a system operation control processor.

The higher level manages all of the processor and includes the level 1 blocks if the system does not include an intermediate level. The higher level may equally include the level ‘n’ blocks if ‘n’ hierarchical levels are introduced. In a simplified structure it could include only the cells as described hereinafter and no intermediary. The structure of the blocks of a given level could be symmetrical (the blocks being identical) or non-symmetrical (the blocks being different). In the present description, which seeks to be typical and of intermediate complexity, a structure will be considered with one level constituting a set of identical level 1 blocks each having a given number ‘JA’ of cells.

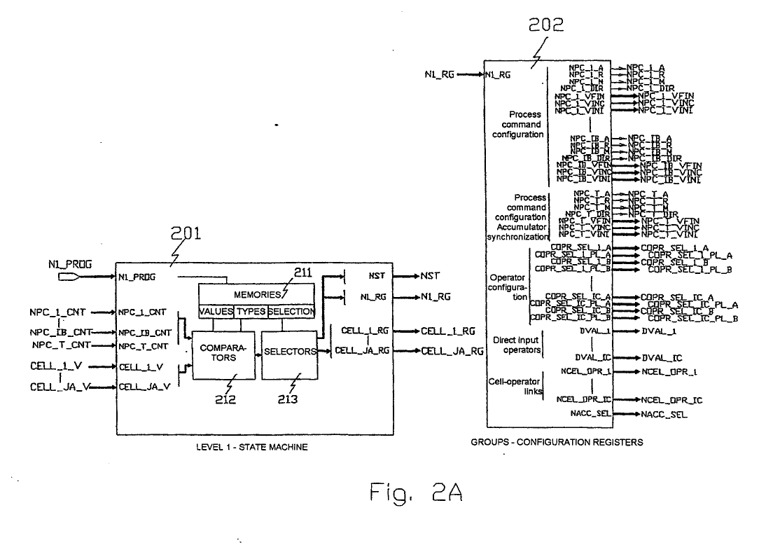

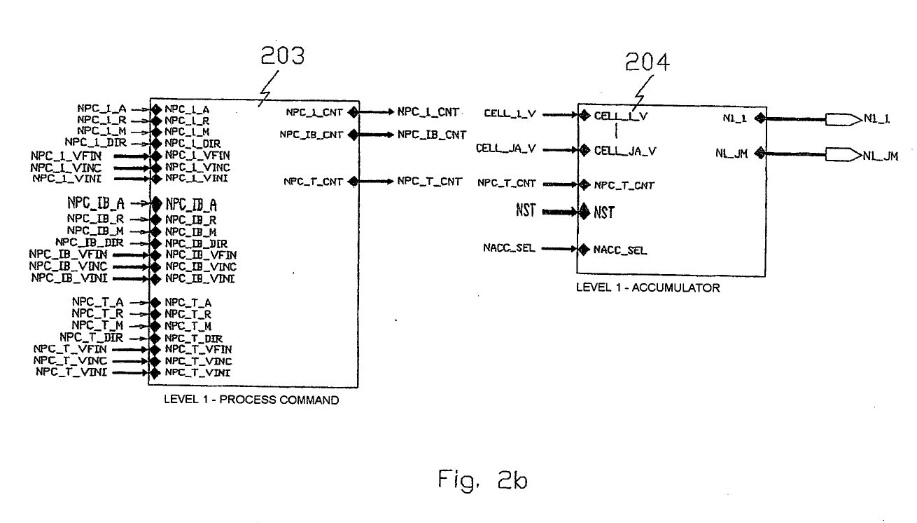

At the higher level the state machine (101, FIG. 1a) effects configuration directly on the level 1 blocks, in particular the setting of the parameters of the state machines of each level 1 block (201, FIG. 2a). The underlying performance is managed by the latter machines, and therefore indirectly and in a decentralized manner by the higher state machine (101).

The higher level state machine (101) manage the operation of the system conjointly with the state machines of the level 1 blocks (201, FIG. 2a).

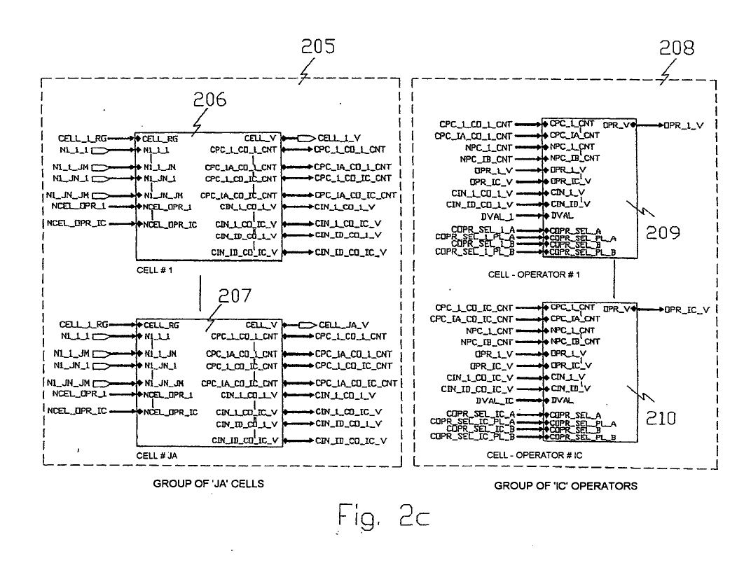

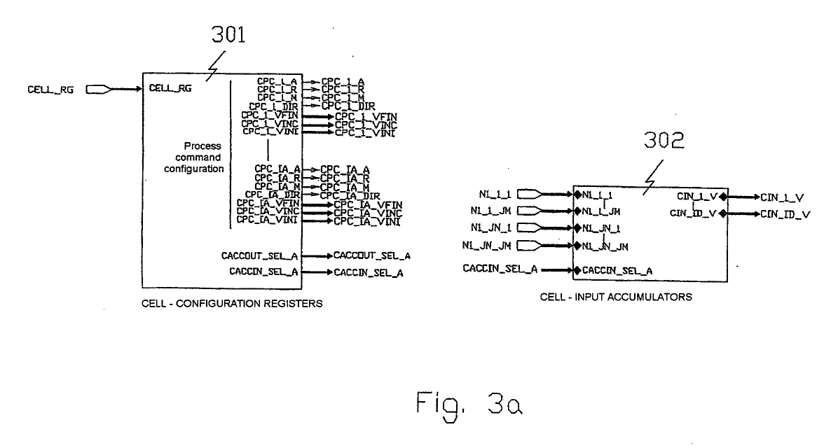

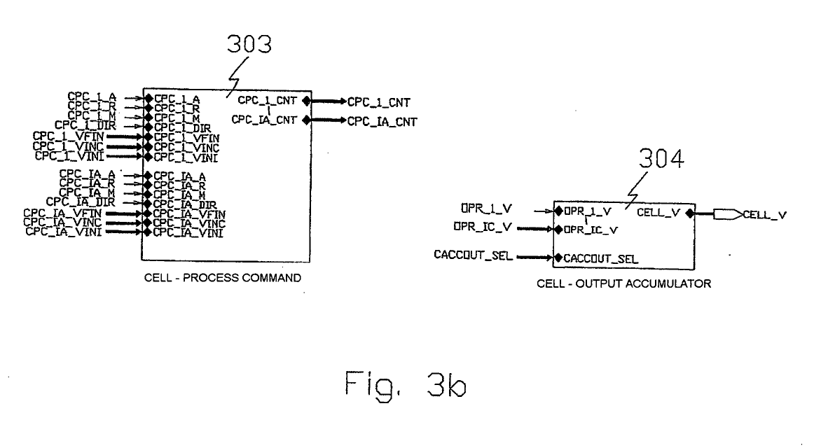

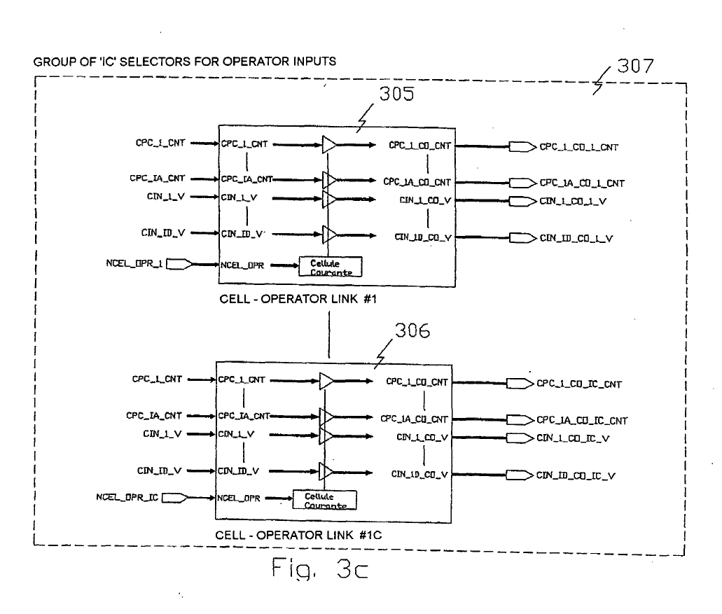

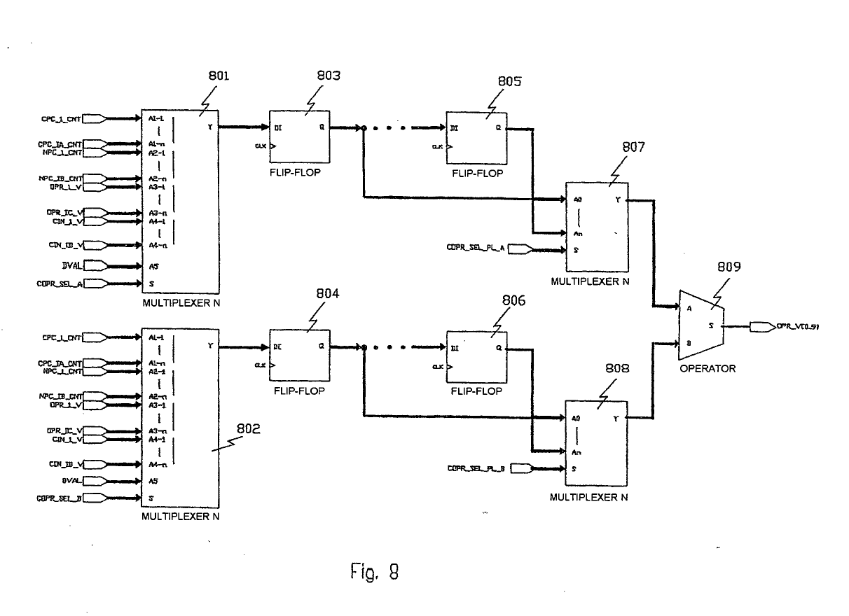

At the level of its logical operation, the higher level state machine (101) is comparable to a microcontroller; in the module (101) the encoding memory block (102) includes the various level 1 configuration codes, i.e. the various registers governing the operation of the elements of the level 1 blocks. To be more precise, the memory blocks (102 to 104) are organized so that the functions to be accomplished are grouped into memory sections as program functions in the manner of a processor; the diverse functions can call others like function calls in software conditionally (on the basis of the results) or unconditionally. The encoding of the operations in the state machines is effected in words of the VLIW (very long instruction word) type comprising the blocks of codes to be transferred to the state machines of the level 1 blocks (201); these blocks to be transferred constitute commands for the hardware of the system; the transfer of memory blocks 101 to the state machine 201 normally occurs on start-up but may be effected at any time. Once the procedure blocks have been transferred, they can be executed by the state machines of the level 1 blocks (201) on the instructions of the higher state machine (101). This hierarchical mode of operation means that decisions from the higher level can be routed to the level 1 blocks (FIG. 2) and ultimately to the elements of the cells (FIG. 3). Thus the transfers between the various state machines constitute all of the code and the execution instructions transmitted from the higher state machine to the others. The VLIW encoding therefore includes the types of operations to be effected, the implied low level configuration, in particular on the operators (FIG. 8), the connections between the various elements including the operators, the configuration of the accumulators, the types of decisions (comparators in particular); all of the above is similar to a microprocessor but decentralized, rendered hierarchical and shared between the state machines of the different levels. Each element can be configured directly or conditionally through the intermediary of the comparators (107) according to the results received at the level 1 result memory blocks (103) (outputs of the Level 1 blocks N1_1_1 to N1_1_JM for the Level 1 block #1 up to N1_JN_1 to N1_JN_JM for the Level 1 block #JN) or the cells result memory blocks (104) (cell outputs CELL_1_1_V to CELL_1_JA_V for the first Level 1 block up to CELL_JN_1_V to CELL_JN_JA_V for the Level 1 block #‘JN’) or even on predefined loops as in programming. The Encoding Memory (102) moves from one address to the next in a sequential order that may be interrupted by the results from the comparators (107) which can selectively instruct a change of addressing of the state machine (101) on the encoding memory (102) according to the results obtained from the memory blocks 103 and 104 the results of which are compared in a configurable manner to one or more values. The routing of the configuration of the level 1 blocks (105 to 106) is identified on the signals N1_1_PROG to N1_JN_PROG for the ‘JN’ level 1 blocks. Either according to the results of comparisons or unconditionally, the execution instructions (addresses) are given immediately to the level 1 state machines (202, FIG. 2a) concerned.

The higher state machine (101) behaves in a similar way to a microprocessor, and could in fact be a microprocessor program if the latter is fast enough to process the information received rapidly. However, an adapted state machine will always offer better performance and be better integrated in that it enables parallel and simultaneous processing of the incoming data and gives instructions in parallel to the state machines of the level 1 blocks (201 2).

In FIG. 1b the ‘JN’ level 1 blocks (109 to 110) whose details are given in FIG. 2 are grouped together (108). Each level 1 block includes the inputs coming from the other level 1 blocks that can be used selectively (by configuration from the state machine 101) for the calculations, and thus each level 1 block has ‘JM’ outputs (N1_1_1 to N1_1_JM for the block 109 up to N1_JN_1 to N1_JN_JM for the JN^{th} block 110) coming from its ‘JA’ cells (actively selected by the accumulator 204 in FIG. 2b). Each level 1 block (109 to 110) also routes the outputs of the respective cells that form part of it (CELL_1_1_V to CELL_1_JA_V for the block 109 up to CELL_JN_1_V to CELL_JN_JA_V for the JN^{th} block 110), or, for example, for blocks each including ‘JA’ cells, although the blocks could all equally well include a different number of cells.

FIGS. 2a to 2c illustrate in detail a level 1 block. A state machine (201) is incorporated in each level 1 block. That machine includes blocks of operations in memory (211). The various operations are transferred beforehand by the first state machine (101, FIG. 1a) at initialization time or as and when required; thereafter the first state machine (101) gives the instructions to execute the various operations in unconditional manner of the instruction call type or conditionally on various results, in particular on the cells and the level 1 blocks. The operations effected as encoded in instructions of VLIW (very long instruction word) type. The VLIW encoding therefore includes the types of operations to be effected, the low level configuration (operators —FIG. 8) involved, the connections between the various elements, the configuration of the accumulators, the types of decisions (comparators in particular). The codes are intended for configuring the cells or the elements of the level 1 block including the process command block (203). As described hereinabove, the codes are either fixed or depend on instructions given by the higher state machine (101, FIG. 1a) or other results incoming to the level 1 state machine (201) entering the comparators (212), in particular the cell output values (CELL_1_V to CELL_JA_V), programmable counters coming from process commands 203 (by NPC_1_CNT to NPC_IB_CNT and NPC_T_CNT) which are also programmed directly under the signal N1_RG determining the process command parameters by the block of configuration registers (202). Each instruction received from the higher state machine (101) or the comparators (212) commands an address or a sequence of addresses in the memories (211) containing a set of values transmitted by the selectors (213) including the data-addresses of registers on level 1 blocks including N1_RG and NST as well as on the cells of the block in particular CELL_1_RG to CELL_JA_RD. Thus the level 1 state machine (201) configures and commands all operations of the level 1 block and the cells that form part of it, and does so dynamically as a function of preprogrammed commands or on the basis of the results obtained.

The group configuration registers block (202) from FIG. 2a supplies the operating parameters of the process command block 203, i.e. the number ‘IB’ of programmable counters of the outputs NPC_1_CNT to NPC_IB_CNT and NPC_T_CNT. The programming of these counters is effected by establishing the initial value (NPC_1_VINI to NPC_IB_VINI and NPC_T_VINI), the final value (NPC_1_VFIN to NPC_IB_VFIN and NPC_T_VFIN), and the increment (NPC_1_VINC to NPC_IB_VINC and NPC_T_VINC). Synchronization is effected by four distinct signals namely reset to 0 (NPC_1_R to NPC_IB_R and NPC_T_R), load values (NPC_1_M to NPC_IB_M and NPC_T_M), counting direction (NPC_1_DIR to NPC_IB_DIR and NPC_T_DIR) and activate count (NPC_1_A to NPC_IB_A and NPC_T_A). Moreover the group configuration registers 202 determine the source values of the inputs A and B of the operators 208 (209, 210, of which there are a number ‘IC’) by the signals COPR_SEL_1_A and COPR_SEL_1_B to COPR_SEL_IC_A and COPR_SEL_IC_B; the same applies to the ‘Pipeline’ commands of the operators at the same inputs via the signals COPR_SEL_1_PL_A and COPR_SEL_1_PL_B to COPR_SEL_IC_PL_A and COPR_SEL_IC_PL_B. The group configuration registers (202) provide direct values DVAL_1 to DVAL_IC available as and when required via one or the other operator input. The group configuration registers (202) determine over a given time period which cell will command the inputs of each operator (NCEL_OPR_1 to NCEL_OPR_IC), the outputs of the operators being independent of the inputs and in fact able to be associated dynamically with different cells at the input and at the output. Finally, the command of the accumulators of the group is determined on the registers (202) by the signal NACC_SEL which selects redirection and combination of the output values of the cells in additive manner or otherwise as required.

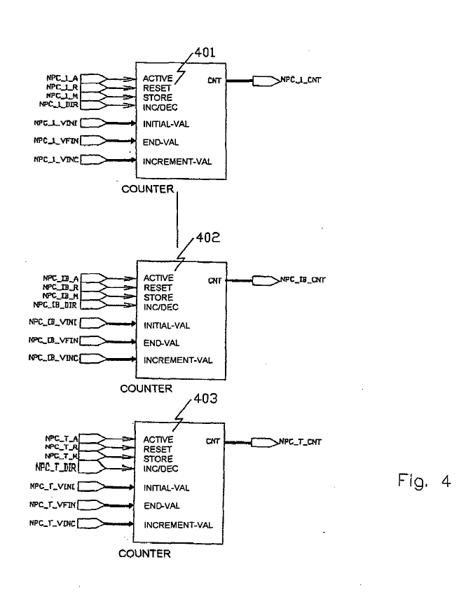

The process command block 203 of FIG. 2b constitutes the command of the processes by programmable counters on initial values, step, modulo, direction which can as required and selectively command the addresses, calculation factors or the indexing of the calculations of the cells, storage or direction of the results. The process command block 203 is shown in detail in FIG. 4 and supplies ‘IB’ distinct count values on the signals NPC_1_CNT to NPC_IB_CNT and NPC_T_CNT.

The ‘JA’ cells 205 as such are summarily grouped in FIG. 2c (206 to 207). The external data incoming to the cells is a choice between the data from registers of the state machine (201); the signals CELL_1_RG to CELL_JA_RG); outputs of the level 1 block accumulators of the ‘JN’ level 1 blocks 108 (of the accumulator 204 of each level 1 block i.e. 109 to 110 on N1_1_1 to N1_1_JM for the level 1 block #1 up to N1_JN_1 to N1_JN_JM for the level 1 block #JN); the selections of the operator inputs by the cells NCEL_OPR_1 to NCEL_OPR_IC The outputs of the cells are identified by the signals CELL_1_V to CELL_JA_V. The cell block is shown in detail in FIG. 3.

The elements 209 to 210 from FIG. 2c constitute the operators 208. These operators 208 constitute the core of the structure of the system. They are shown in detail in FIG. 8. The operator inputs are from diverse sources: either process command inputs from the source cell selected for each operator at a given time by the signals NCEL_OPR_1 to NCEL_OPR_IC selecting the selected cell process command signals for each operator at a given time in this instance (CPC_1_CO_1_CNT to CPC_IA_CO_1_CNT) to (CPC_1_CO_IC_CNT to CPC_IA_CO_IC_CNT) for ‘A’ command signals on IC operators activated on one cell at a time at a given time for each operator, level 1 block process command inputs (NPC_1_CNT to NPC_IB_CNT), other operator outputs (OPR_1_V to OPR_IC_V), cell input accumulators, also for each operator at a given time by the signals NCEL_OPR_1 to NCEL_OPR_IC selecting the selected cell accumulator input signals for each operator at a given time i.e. (CIN_1_CO_V to CIN_ID_CO_1_V) up to (CIN_1_CO_IC_V to CIN_ID_CO_IC_V) or direct register values (DVAL_1 to DVAL_IC) supplied by the level 1 configuration registers (202). The selection of the ‘A’ operator inputs is determined by the signals COPR_SEL_1_A to COPR_SEL_IC_A and the pipelines of the ‘A’ operator inputs is determined by the signals COPR_SEL_1_PL_A to COPR_SEL_IC_PL_A, the selection of the ‘B’ operator inputs is determined by the signals COPR_SEL_1_B to COPR_SEL_IC_B and the pipelines of the operator inputs ‘B’ are determined by the signals COPR_SEL_1_PL_B to COPR_SEL_IC_PL_B; all of these command signals come from the Configuration Register Groups block 202.

The level 1 block accumulator (204) captures the outputs of each cell (CELL_1_V to CELL_JA_V).

The accumulator output redirection commands are determined by different signals selected by the state of the signal NACC_SEL coming from the configuration register block 202. The accumulator output commands come from the choice (by NACC_SEL) of the synchronization counter NPC_T_CNT, the programmable state register NST coming from the level 1 state machine (201), or other sources.

The level 1 accumulator is shown in detail in FIG. 5. There are ‘JM’ resulting outputs from the accumulator and they stem from programmed combination of the outputs of the cells of the level 1 block.

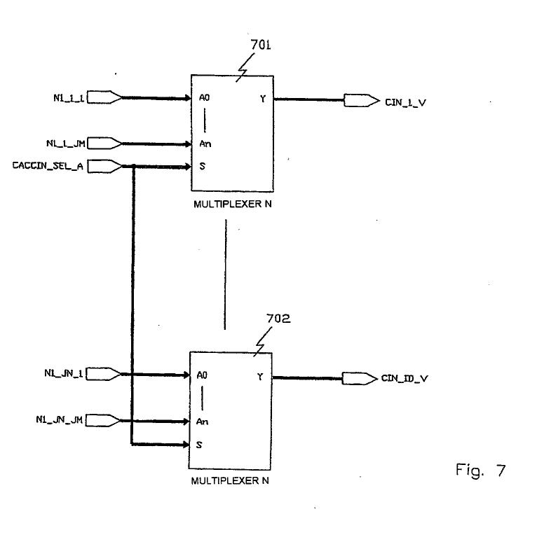

FIGS. 3 (3a, 3b, 3c) illustrate in detail a typical cell. That is to say at the input of the cell 302—input accumulator, routing the inputs of the cell to the operators. The input accumulator of cell 302 captures the outputs of the ‘JN’ level 1 blocks each on ‘JM’ outputs (N1_1_1 to N1_1_JM for the level 1 block #1 up to N1_JN_1 to N1_JN_JM for the level 1 block #JN). The signal CACCIN_SEL_A comes from the configuration registers of the cell (301) and chooses ‘ID’ available signals from the incoming signals and makes them available to the operators (CIN_1_V to CIN_ID_V). The input accumulators are shown in detail in FIG. 7.

Like the level 1 blocks (FIG. 2) the cells include process command cells (303) specific to each cell. The configuration registers of each cell (301) supply in particular the parameters of the process command block 303, i.e. the number ‘IA’ of programmable counters of the outputs (CPC_1_CNT to CPC_IA_CNT). The programming of these counters is effected by the configuration registers (301) by establishing the initial value (CPC_1_VINI to CPC_IA_VINI), the final value (CPC_1_VFIN to CPC_IA_VFIN), and the increment (CPC_1_VINC to CPC_IA_VINC). The synchronization is effected by four separate signals i.e. reset to zero (CPC_1_R to CPC_IA_R), load values (CPC_1_M to CPC_IA_M), counting direction (CPC_1_DIR to CPC_IA_DIR) and activate counting (CPC_1_A to CPC_IA_A).

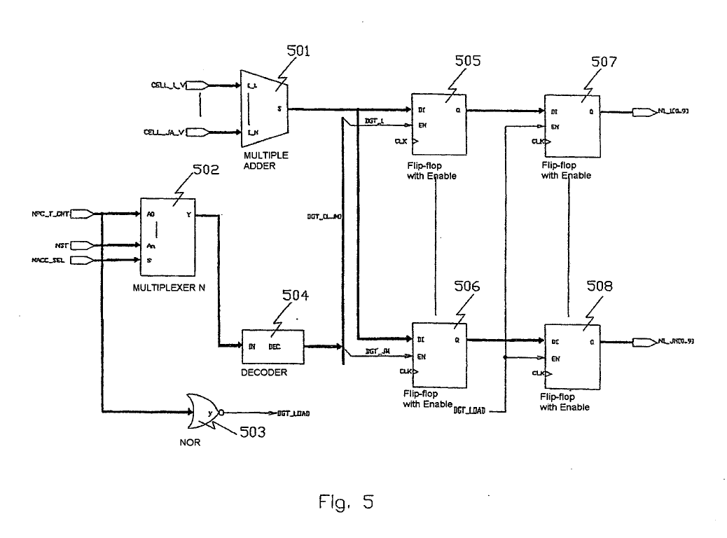

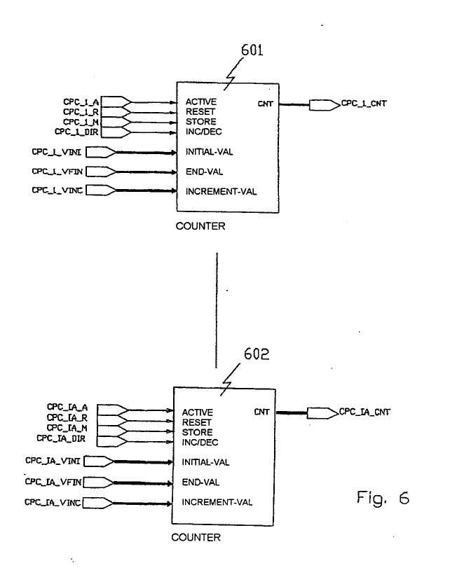

The selectors of the operator inputs 305 to 306 of FIG. 3c route the ‘IC’ operator inputs (307) that come from the cells, that is to say for the chosen cell in a given time for each operator: in this instance the signals coming from the process command cell 303 (described in detail with reference to FIG. 6) of the cell CPC_1_CNT to CPC_IA_CNT and the signals CIN_1_V to CIN_ID_V coming from the input accumulators of the cell 302. Note that the other operator inputs come from other resources including the groups and therefore do not pass through the selectors 305 to 306. This selection operation is effected for each of the ‘IC’ operators, the passage to the operators is chosen by the signals NCEL_OPR_1 to NCEL_OPR_IC supplied by the configuration registers of the group (202 in FIG. 2a), that is to say for each operator the value determining at a given time from which cell the cell level inputs come. First of all the outputs of the operator input selectors 305 to 306 i.e. CPC_1_CO_1_CNT to CPC_1A_CO_1_CNT up to CPC_1_CO_IC_CNT to CPC_1A_CO_IC_CNT for ‘IC’ operators. Then the outputs of the operator input selectors 305 to 306 i.e. CIN_1_CO_1_V to CIN_IA_CO_1_V up to CIN_1_CO_IC_V to CIN_1A_CO_IC_V of a given cell correspond to the incoming signals CIN_1_V to CIN_1A_V from the cell routed to one or more operators always in accordance with the command inputs NCEL_OPR_1 to NCEL_OPR_IC. All these outputs of the operator input selectors 305 to 306 are active at a given time only for a given operator link selector i.e. on the cell chosen (respectively by NCEL_OPR_1 to NCEL_OPR_IC) at a given time for commanding that operator by the data that it routes there. The output of each cell from FIG. 3 is determined by the output accumulator block 304. The accumulator block 304 selects the output of the operator (OPR₁₁—V to OPR_IC_V) that constitutes the effective output of the cell, the selection being effected by the signal CACCOUT_SEL that comes from the configuration register block 301. In this instance an operator having an output assigned to a given cell output may equally well have its inputs coming from another cell.

FIG. 4 illustrates in detail the process command module of the level 1 block (203) from FIG. 2b. Each level 1 block includes such a module which supplies global synchronization signals for the cells that it contains, in this instance ‘IB’ programmable counters (401 to 402) for managing progressive factorization data, addressing or operation loops. The synchronization signals are NPC_1_CNT to NPC_IB_CNT and may be directed selectively and in any combination to the inputs of the various operators. Moreover a supplementary programmable counter (403) is used for timing the accumulators of the current level 1 block (204) in FIG. 2b, in particular enabling progressive selection of the cell outputs to various outputs of the level 1 block, which enables crossed calculations, for example, or matrix calculations.

The various counters 401 to 403 of FIG. 4 are programmed by the configuration registers (202—FIG. 2a). Various values are established in these counters beforehand, as follows:
The initial value (NPC_1_VINI to NPC_IB_VINI and NPC_T_VINI), this data constitutes the starting value of the counter or the return value after a complete counting cycle.
The final value (NPC_1_VFIN to NPC_IB_VFIN and NPC_T_VFIN), this data constitutes the end of counting cycle value from which a new cycle begins on the initial value.
The increment (NPC_1_VINC to NPC_IB_VINC and NPC_T_VINC). This data constitutes the progression value of the counter either for incrementation or for decrementation according to the direction determined.

Command and synchronization are effected by four separate signals i.e.:
Reset to zero (NPC_1_R to NPC_IB_R and NPC_T_R), on this signal the counter is set to zero and stops counting.
Load values (NPC_1_M to NPC_IB_M and NPC_T_M), on this signal the counter loads the three values (initial, final, incrementation).
Counting direction (NPC_1_DIR to NPC_IB_DIR and NPC_T_DIR). The counter progresses upward or downward by the given increment value.
Activate counting (NPC_1_A to NPC_IB_A and NPC_T_A). Command to start the counter.

These counter commands can be sent specifically to each counter or to a plurality of counters simultaneously, the configuration register 202 decoding a series of addresses corresponding to specific counters or to a set of counters. Thus, as may be required, all of the structure or a portion of the structure of a level 1 block may be synchronized precisely (the same applies to a plurality of level 1 blocks, by means of supplementary addressing).

FIG. 5 shows the output accumulator of the level 1 block (204) from FIG. 2b. Overall, this circuit processes the data leaving the cells of each level 1 block. In fact each cell output is represented therein CELL_1_V to CELL_JA_V for ‘JA’ cells in a given level 1 block. The cell values are added thereto in the adder block (501). The latter values are represented so as to be added globally but it is possible to introduce a selector controlled by a state machine that chooses the cells to be added, in which case a selector is introduced between the adder (501) and the cell outputs. The addition results are directed to flip-flops (505, 506) to be stored therein, the choice of the flip-flop that will store the addition value is effected on each clock cycle and may in particular be determined by the global counter NPC_T_CNT (block 403 from FIG. 4) or by a state NST coming from the state machine of the level 1 block (201 in FIG. 2a), the choice of the source signal determining the recording of one or the other flip-flop (505, 506) is effected by the signal NACC_SEL coming from the configuration register (202—FIG. 2a). A multiplexer (502)/decoder (504) pair is represented for choosing one and only one flip-flop for storing an addition to a cycle, but the multiplexer 502 and the decoder 504 could be replaced by a bit field each bit whereof would select which flip-flops (one or more) would store at a given time the values produced by the adder 501. Finally, a second group of flip-flops (507, 508) loads the values of the first row of flip-flops, in the example this is effected at the end of a count of NPC_T_CNT on the NOR gate 503, but could equally be a programmable and variable condition such as a combination of values of NPC_T_CNT, a state machine replacing the NOR gate 503, a fixed value in particular. Thus ‘JM’ values are available cyclically at the outputs of the flip-flops 507, 508 for subsequent processing.

FIG. 6 shows in detail a process command cell (303 in FIG. 3b). Each cell contains a group of ‘IA’ counters the values whereof are available for synchronization, addressing memories, factorization on the various operators: in this instance ‘IA’ programmable counters (601 to 602) for managing progressive factorization data, addressing or operation loops. The synchronization signals are CPC_1_CNT to CPC_IA_CNT and may be directed selectively and in any combination to the inputs of various operators. The various counters 601 to 602 from FIG. 6 are programmed by the configuration registers (301-FIG. 3a). Various values are established in these counters beforehand:
The initial value (CPC_1_VINI to CPC_IA_VINI), this data constitutes the counter starting value or return value after a complete counting cycle.
The final value (CPC 1_VFIN to CPC_IA_VFIN), this data constitutes the end of counting cycle value from which a new cycle begins on the initial value.

The increment (CPC_1_VINC to CPC_IA_VINC). This data constitutes the progression value of the counter either for incrementation or for decrementation according to the direction determined.

Command and synchronization are effected by four separate signals i.e.:
Reset to zero (CPC_1_R to CPC_IA_R), on this signal the counter is set to zero and stops counting.
Load values (CPC_1_M to CPC_IA_M), on this signal the counter loads the three values (initial, final, incrementation).
Counting direction (CPC_1_DIR to CPC_IA_DIR). The counter progresses upward or downward by the given increment value.
Activate counting (CPC_1_A to CPC_IA A). Command for starting the counter.

These counter commands can be sent specifically to each counter or to a plurality of counter simultaneously, the configuration register 301 decoding a series of addresses corresponding to specific counters or to a set of counters. Thus as may be required the structure or a portion of the structure of a cell may be synchronized precisely (the same applies to a plurality of cells, by means of supplementary addressing).

FIG. 7 shows in detail the input accumulators of a cell (302 in FIG. 3a). The input signals of the cell are in particular outputs of accumulators of level 1 blocks i.e. N1_1_1 to N1_1_JM for ‘JM’ outputs of the level 1 block #1 up to N1_JN_1 to N1_JN_JM for ‘JM’ outputs of the level 1 block #JN. Another possible choice that may be added and is not represented in FIG. 7 may also consist of the outputs from the other cells of a given level 1 block, for example the outputs of the ‘JA’ cells of the same level 1 block as the current cell i.e. the outputs CELL_1_V to CELL_JA_V of the cells 1 to ‘JA’ of a given level 1 block. The selection of the inputs is effected by multiplexers 701, 702 in FIG. 7 on the command CACCIN_SEL_A coming from the configuration registers (301—FIG. 3a), thus there are ‘ID’ multiplexers the data supplied selectively to the cell is CIN_1_V to CIN_ID_V and may be chosen on the various operators.

FIG. 8 represents in detail the operator (209 to 210 in FIG. 2c) dynamically assigned to a selected cell at a given time at its inputs. The operator is the resource at which the system data converges and is processed, and thus constitutes the operational core of the system. The operator has inputs and an output. An operator typically has two inputs like an adder arithmetic operator, multiplier on inputs A and B; like a logic operator on inputs A and B; like a non-linear operator, a comparator; like a storage operator on address/data inputs. The architecture of the system can nevertheless support a greater number of inputs if required, in particular data such as A and B, or commands (subtract/add, store—‘write memory’).

The multiplexing modules 801 and 802 in FIG. 8 effect the selection of the incoming data from the operator, two in the present example. Into these multiplexer modules 801 and 802 are introduced the values available for the operator, i.e. in particular:
The counters CPC_1_CNT to CPC_IA_CNT coming from the process command block of the cell (303 in FIG. 3b) of a dynamically selected cell.
The counters NPC_1_CNT to NPC_IB_CNT coming from the process command block of the level 1 block (203 in FIG. 2b).
Outputs from other operators OPR_1_V to OPR_IC_V coming from the operator blocks (209 to 210 in FIG. 2c).
The input accumulator 302 in FIG. 3a in detail in FIG. 7 on the signals CIN_1_V to CIN_ID_V. This accumulator processes data external to the selected cell i.e. in particular outputs of accumulators of level 1 blocks (N1_1_1 to N1_1_JM of the level 1 block #1 to N1_JN_1 to N1_JN_JM of the level 1 block #JN) as indicated in FIG. 7, or otherwise outputs of other cells CELL_1_V to CELL_JA_V of the same level 1 block, this latter case is not represented but is equally possible.
Direct data DVAL coming from configuration registers (202 FIG. 2a) available for each operator of cell selected as input.
Other inputs not represented: cyclic values in memory, external interface inputs (ports), etc.

The selection on the multiplexing modules 801 and 802 in FIG. 8 is effected by the signals COPR_SEL_A to COPR_SEL_B respectively for the inputs A and B, these selection signals coming from the group configuration module (202 in FIG. 2a) on the signals COPR_SEL_1_A to COPR_SEL_IC_A and COPR_SEL_1_B to COPR_SEL_IC_B. Once the inputs of a given operator are chosen they must be synchronized appropriately. The ‘IC’ operators are interlinked, which implies that the calculations are effected over separate clock cycles, and it may therefore happen that on a given operator an input has passed through two operators for example (delay of two clock cycles) and that the other input has passed through four operators for example (delay of four clock cycles), in which case the first input is in advance by two clock cycles, now on the processing in the operation block (809 in FIG. 8) that receives these two inputs, the latter must be coherent (on the same clock cycle), in the case of this example the first signal must be delayed by two clock cycles. The series of flip-flops (803, 805, 804, 806) adjust these clock cycles. Thus the delay of clock cycles or the adjustment of latency of the inputs of the operator is effected selectively on the choice of the output of the flip-flop by the multiplexers 807 and 808 from FIG. 8. In the example the first signal passes through three successive flip-flops and the second input passes through a single flip-flop. The command for selection of the delays on the multiplexers (807 which chooses on the series of flip-flops 803-805; 808 which chooses on the series of flip-flops 804-806) is respectively COPR_SEL_PL_A and COPR_SEL_PL_B, these commands coming from the cell configuration register block (301 in FIG. 3a) on the signals COPR_SEL_1_PL_A to COPR_SEL_IC_PL_A and COPR_SEL_1_PL_B to COPR_SEL_IC_PL_B.

In FIG. 8 the function of the operator is finally effected by the module 809. Depending on the implantation of the system, this operator is an arithmetic (fixed or floating point), logic or memory function; in particular and non-exhaustively:
Arithmetic: adder/subtractor, multiplexer, divider, linear/non-linear function, incrementation/decrementation, etc.
Logic: comparator (equal to, greater than, less than, etc.), left-right shifter (barrel shifter), etc.
Memory: write/read, function table, etc.

Thus on a given group of cells including a group of ‘IC’ operators, it could for example have two addition/subtraction operators, one multiplier, three addressable memories, one logic bit shifter, one non-linear function table, two comparators, etc. And as indicated hereinabove the operators may equally have more than two inputs as shown in the diagrams. The output of the operator is the signal OPR_V, on a cell we have OPR_1_V to OPR_IC_V for a number ‘IC’ of operators. As indicated hereinabove these outputs are treated at the level of the level 1 blocks or can be redirected to other cells. Where appropriate operators could be intended in fixed manner for cells.

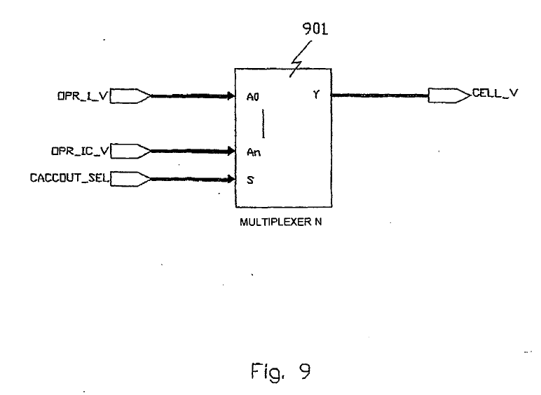

FIG. 9 represents the cell output accumulator (304 in FIG. 3b).

In this module the output of an operator of a given cell is essentially chosen the operator the result whereof constitutes also the output of the cell. Thus on the multiplexer 901, the ‘IC’ outputs of the ‘IC’ operators OPR_1_V to OPR_IC_V; the selection command CACCOUT_SEL comes from the cell configuration register module (301 in FIG. 3a).

1. Method of managing resources of a modular processor system said processor managing different data in order to obtain results, said data being processed by elements situated on different hierarchical levels and organized in accordance with a flexible architecture, said elements comprising:
operators situated on the base level, said operators comprising logic, arithmetic, non-linear operator, comparator or storage functions;
cells situated on the intermediate level said cells transmitting the data coming from the operators or to the operators;
blocks situated on the higher level and constituted of groups of cells, said blocks comprising a lower level state machine transmitting the results coming from the cells;
said method comprising the steps of:
transmission of an instruction of a program contained in a first higher level state machine to the lower level state machine for managing the execution of the program;
assignment of links between the various cells that contain the incoming data and the operators of the block of the lower level state machine to effect the placement of said incoming data;
assignment of links between the operators of a block of the lower level state machine for effecting the processing of said incoming data;
assignment of links between the various operators by the lower level state machine, at the time of the execution of the instructions of the program, as a function of the outgoing data obtained from the processing of the incoming data,
characterized in that the method comprises the step of giving instructions to the lower level state machine by the higher level state machine, by the output values of the cells and by the outputs of a process controller, that process controller being constituted of programmable counters that can direct the results as required and selectively.

2. Method according to claim 1 further comprising a step of routing the input and output data dynamically and independently at each input, output and operator and on the basis of particular values in predefined memories corresponding to the links between the sources and the destinations.

3. Method according to claim 1, further comprising a step of transmission of the incoming data directed dynamically to the groups of operators from an external processor or from input interfaces from external devices, the routing of the data to the groups of operators being reconfigurable dynamically as required.

4. Method according to claim 1, further comprising a step of transmission of the outgoing data to memories or external devices or output interfaces.

5. Method according claim 1, further comprising a step of configuration of the inputs of the various arithmetic and logic operators grouped into blocks, shared between cells and accessible to cells chosen dynamically.

6. Method according to claim 1, further comprising a step of configuration of the inputs of the various arithmetic and logic operators partly assigned to cells according to the configuration requirements.

7. Method according to claim 1, further comprising a step of selection of the source of each input for each input of each operator.

8. Method according to claim 1, further comprising a step of capture of output data of cells in the form of accumulators for selecting the output data in the remainder of the processing of the data.

9. Method according to claim 1, further comprising a step of synchronization in the form of programmable counters for sequentially commanding the execution of the calculations by loops or sequential addressing, regardless of the stage of processing of the data.

10. Method according to claim 1, further comprising assignment elements contained in the cells for assigning data links, which links are internal or external to the cells.

11. Method according to claim 7, further comprising a step of selection of the sources of the inputs of operators in particular arithmetic, logic, storage functions, which selection routes the outputs of other elements whether that be other operators, cells, blocks, programmable counters or other elements, input data to one or the other input of each operator, independently for each input of each operator.

12. Method according to claim 1, further comprising a step of selection of the sources of the inputs of cells, which selection routes the outputs of other elements whether that be cells, blocks or selective accumulators of blocks, programmable counters, operators or other elements, input data to one or the other input of each cell, independently for each input of each cell.

13. Method according to claim 1, further comprising a step of selection of the sources of the inputs of blocks of cells called level 1 blocks or higher level blocks incorporating lower level blocks, which selection routes outputs of other elements whether that be cells, blocks or selective accumulators of groups, programmable counters, operators or other elements, direct data to one or the other input of each block, independently for each input of each block.

14. Method according to claim 1, further comprising a step of grouping of calculation or processing elements comprising:
memories, logic or arithmetic operators;
a device for selection of links between the elements of the cell at the inputs and outputs;
a device for selection of the links external to the cell enabling connection of different inputs or outputs of cells, operators, accumulators of cells, groups of cells or input data.

15. Method according to claim 1, further comprising a cell process command step comprising:
programmable counters;
counter commands for the start, end and incrementation/decrementation values;
counter commands for activation of counting, setting to zero, loading of programming values and counting direction.

16. Method according to claim 1, further comprising a step of selective accumulation of the inputs of the cells comprising:
outputs of elements to be selected including outputs of other cells, outputs of groups of cells, outputs of accumulators of groups of cells, outputs of operators, etc.;
a device for selection of inputs from programmed registers or programmed state machines, etc.

17. Method according to claim 1, further comprising a step of grouping of cells enabling grouping of cells comprising:
memories, logic or arithmetic operators available to receive data from cells or from other sources, calculate and route results to other cells;
a device for selection of links between the cells at the inputs and outputs;
a device for selection of links external to the group enabling connection of different inputs or outputs of cells, operators, accumulators of cells, groups of cells or input data.

18. Method according to claim 1, further comprising a cell group process command step comprising:
programmable counters;
counter commands for the start, end and incrementation/decrementation values;
counter commands for activation of counting, setting to zero, loading programming values and counting direction.

19. Method according to claim 1, further comprising a step of selective accumulation of the outputs of the cells comprising:
stored cell outputs;
a programmable selection device for choosing the values of cells to be added in a given clock cycle;
a device for commanding selection of values from counters or programmable state machines that commands the device for selection of cells to be added in a given cycle;
a programmable selection device for choosing the cell accumulators over a given clock cycle;
a device for commanding the selection of values from counters or programmable state machines commanding the device for selection of the accumulators over a given cycle;
a parallel adder of the values of the cells with selection of the inputs by the device for selection of outputs of cells to be added to a given cycle;
memories commanded selectively to assume the values added in a chosen cycle;
memories commanded cyclically for synchronizing the outputs of the memories selected over chosen cycles and transmitted over other cycles.

20. A system for executing the steps of the method according to claim 1.

21. A computer program comprising instructions for executing the method according to claim 1.
